(19) United States
(12) Patent Application Publication
(10) Pub. No.: US 2006/0034581 A1
(43) Pub. Date: Feb. 16, 2006

(54) Media device featuring synchronized playback

(75) Inventors: David Konetski, Austin, TX (US); William Allen Curtis, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/915,615

(22) Filed: Aug. 10, 2004

(51) Int. Cl. H04N 5/76

(52) U.S. Cl. 386/46; 386/125

(57) ABSTRACT

In a first embodiment, a packet, in response to which two or more media players begin playbacks of a piece of media content at a substantially same time, is output. In a second embodiment, a packet is received, and in response to the packet, a time at which to begin a playback of a piece of media content is determined.

### BACKGROUND

The description herein relates generally to media devices, and more particularly to networked media devices.

As the value and use of information continue to increase, individuals and businesses seek additional ways to process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

IHSs are sometimes used to store and play a piece of digital media content (e.g., a piece of digital audio content such as a piece of content stored by MPEG Layer 3 (“MP3”) files and wave format (“WAV”) files). In one example, an IHS, functioning as a media server, stores one or more digital media files and outputs the files over a network to two or more digital media players (e.g., digital audio receiver (“DAR”)), which, outputs (e.g., plays), digital content stored by such files, as analog signals. In such situation, each of the digital players may begin playing a single piece of digital content at different times, causing various problems including echo, beating, and and/or acoustic cancellation.

### SUMMARY

In a first embodiment, a packet, in response to which two or more media players begin playbacks of a piece of media content at a substantially same time, is output.

In a second embodiment, a packet is received, and in response to the packet, a time at which to begin a playback of a piece of media content is determined.

### BRIEF DESCRIPTION OF THE DRAWINGS

FIG. 1 is a block diagram of a system according to the illustrative embodiment.

FIG. 2 is a block diagram of an information handling system that is representative of a media server of FIG. 1, according to the illustrative embodiment.

FIG. 3 is a block diagram of an information handling system that is representative of a media player of FIG. 1, according to the illustrative embodiment.

FIG. 4 is a timing diagram illustrating various information associated with operations of the system 100 of FIG. 1, according to the illustrative embodiment.

FIG. 5 is a flow chart of operations of a process executed by a media player of FIG. 1.

### DETAILED DESCRIPTION

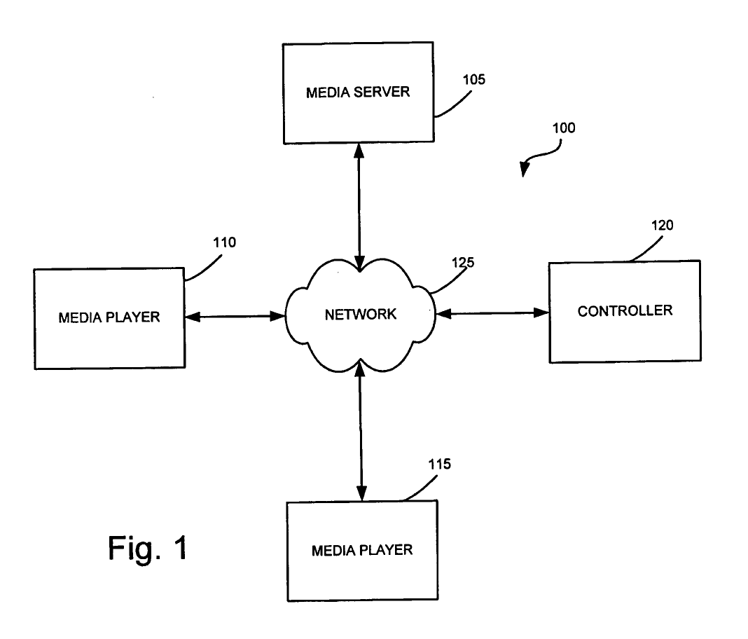

FIG. 1 is a block diagram of a system, indicated generally at 100, according to an illustrative embodiment. The system 100 includes a media server 105, media players (or media devices) 110 and 115, and a controller 120. Also, the system 100 includes a network, such as a Transport Control Protocol/Internet Protocol (“TCP/IP”) network. In the illustrative embodiment, the network 125 is a wireless network (e.g., one of Institute of Electrical and Electronics Engineers (“IEEE”) 802.11 series of networks). However, in at least one alternative embodiment, the network 125 is a wired network (e.g., a 10/100 Base T network).

Each of the media server 105, the media players 110 and 115, and the controller 120 includes a network interface for communicating with the network 125 (e.g., outputting information to, and receiving information from, network 125), such as by transferring information (e.g., instructions, signals, data) between such media server, media players, controller, and the network 125. Accordingly, through the network 125, each of the media server 105, the media players 110 and 115, and the controller 120 communicates with one another.

For clarity, FIG. 1 depicts only one media server 105, although the system 100 may include additional media servers which are substantially identical to one another. Similarly for clarity, FIG. 1 depicts only two media players 110 and 115, although the system 100 may include additional media players which are substantially identical to one another. Likewise for clarity, FIG. 1 depicts only one controller 120, although the system 100 may include additional controllers which are substantially identical to one another. In the discussions below, the media player 110 is a representative of the media players 110 and 115.

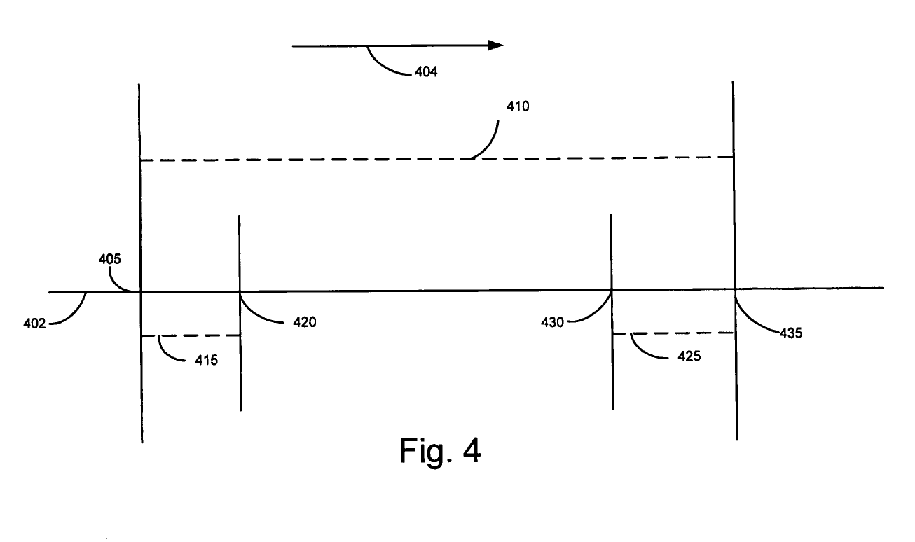

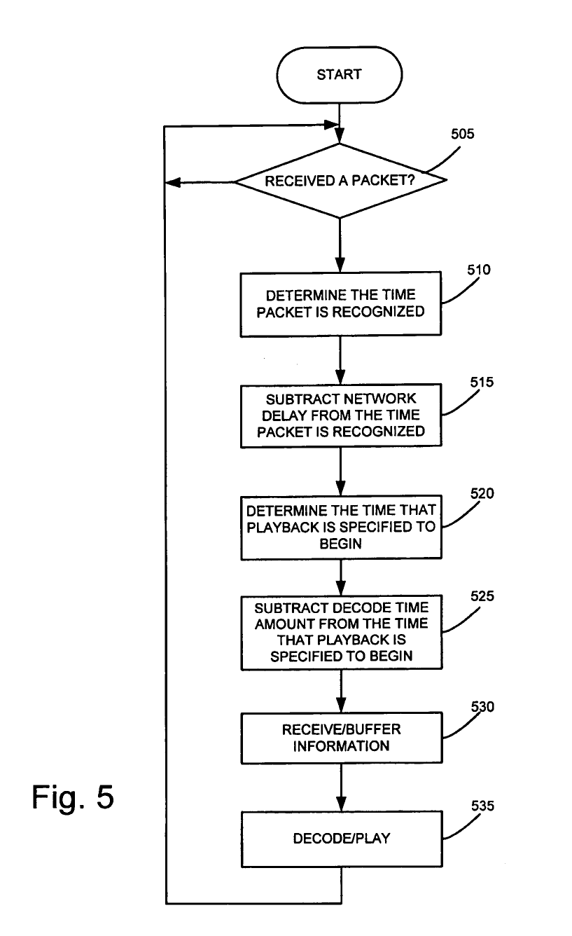

Each of the media server 105, the media players 110 and 115, and the controller 120 is an information handling system (“IHS”) for executing processes and performing operations (e.g., processing and communicating information) in response thereto, as discussed in more detail below (in connection with FIGS. 4 and 5). Each such IHS is formed by various electronic circuitry components. Moreover, as shown in FIG. 1, all such IHSs are coupled to one another. Accordingly, each of the media server 105, the media players 110 and 115, and the controller 120 operates within the network 125.

For purposes of this disclosure, an IHS includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. Example of an IHS include, personal computer (“PC”), a network storage device, personal digital assistant (“PDA”), or any other suitable device with variations in size, shape, performance, functionality, and price. An IHS also includes other components such as, random access memory (“RAM”), one or more processing resources (e.g., central processing unit (“CPU”)), hardware or software control logic, read only memory (“ROM”), other types of memory, one or more disk drives, one or more network interfaces, one or more input/output devices and/or one or more buses.

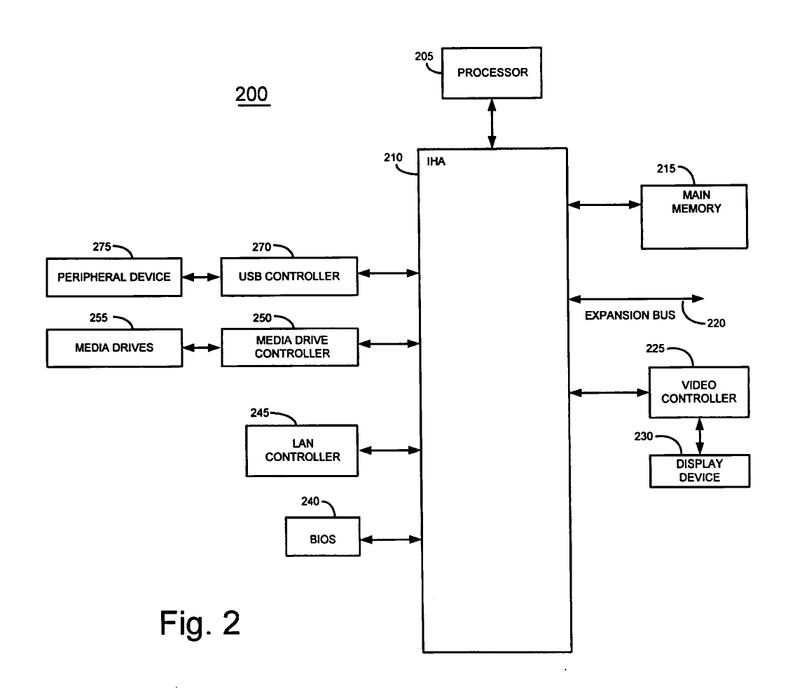

FIG. 2 is a block diagram of an IHS, indicated generally at 200, that is representative of the media server 105 according to the illustrative embodiment. The IHS 200 includes a processor 205 (e.g., an Intel Pentium series processor). An Intel Hub Architecture (IHA) chipset 210 provides the IHS 200 with graphics/memory controller hub functions and I/O functions. More specifically, the IHA chipset 210 acts as a host controller which communicates with a video controller 225 coupled thereto. A display device 230 is coupled to the video controller 225.

The chipset 210 further acts as a controller for main memory 215 which is coupled thereto. The chipset 210 also acts as an input/output (“I/O”) controller hub (ICH) which performs I/O functions. A USB controller 270 is coupled to chipset 210 so that devices such as a print device 275 can be connected to the chipset 110 and the processor 205. A system basic input-output system (“BIOS”) 240 is coupled to chipset 210 as shown. The BIOS 240 is stored in CMOS or FLASH memory so that it is nonvolatile.

A local area network (“LAN”) controller 245, alternatively called a network interface controller (“NIC”), is coupled to the chipset 210 to facilitate connection of the IHS 200 to other IHSs via a network (e.g., the network 125). A media driver controller 250 is coupled to chipset 210 so that devices such as media drives 255 can be connected to the chipset 210 and the processor 205. Examples of the media devices 255 capable of being coupled to the media controller 250 include CD-ROM drives, DVD drives, hard disk drives and other fixed or removable media drives. An expansion bus 220, such as a PCI bus, PCI Express bus, serial advanced technology attachment (“SATA”) bus or other bus is coupled to the chipset 110 as shown. The expansion bus 220 includes one or more expansion slots (not shown) for receiving expansion cards which provide the IHS 200 with additional functionality.

Referring again to FIG. 1, the media server 105 stores one or more pieces of media content (e.g., pieces of digital media content) in its media drive (e.g., one or the media drives 255). In one example, the media server 105 stores such contents in MPEG Layer 3 (“MP3”) file format. The media server 105 provides (e.g., outputs in response to a request) such pieces of media content to the media player 110, which receives the pieces of media content from the media server 105. In the illustrative embodiment, the media server 105 outputs the pieces of media content in response to a request received from the media player 110. In one example, the media player 110 plays a piece of media content by decoding the piece into one or more analog signals, and outputting the analog signals to one or more speakers.

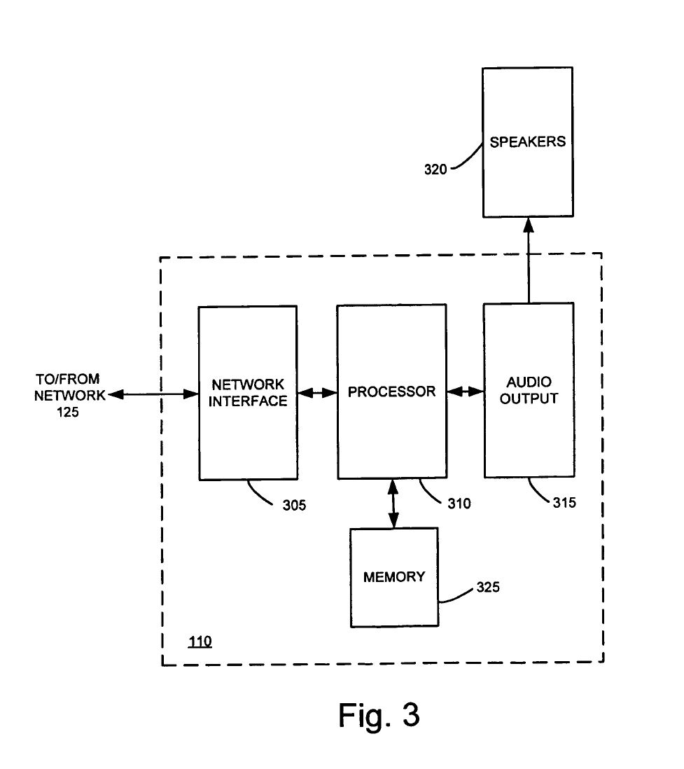

FIG. 3 is a block diagram of the media player 110 of FIG. 1 according to the illustrative embodiment. An example of the media player 110 includes a digital audio receiver (“DAR”). In at least one embodiment, the media player 110 is embedded in another device (e.g., a consumer electronic device such as an alarm clock). In other embodiments, the media player 110 is portable device such as a hand held device.

As discussed above, the media player 110 is an IHS and includes a NIC 305 for outputting information to and receiving information (e.g., information included by an MP3 file or a WAV file) from the network 125. The NIC 305 is substantially similar to the NIC 145 of the IHS 200. The media player 110 also includes a processor 310 coupled to the NIC 305 for executing one or more processes as discussed in more detail below (in connection with FIGS. 4 and 5).

The media player 110 includes an audio controller 315, which is coupled to the processor 310 and one or more speakers 320. Accordingly, via the audio controller 315, the media player 110 outputs one or more audio signals to the speakers 320.

The media player also includes a memory 325 coupled to the processor 310. In the memory 325, the media player 110 stores various information, discussed in more detail further below (in connection with FIGS. 4 and 5), associated with its processes.

FIG. 4 is a timing diagram illustrating various information associated with operations of the system 100, according to the illustrative embodiment. In FIG. 4, a time axis 402 represents a flow of time, which flows in a direction shown by an arrow 404.

At a time 405 (“Tsync”), the media server 105 outputs a packet (e.g., a sync packet) to the media players 110 and 115. The packet includes an amount of time interval (“Tdelay”), represented by a dashed line 410. Each of the media players 110 and 115 is instructed to begin playing a specified piece of media content after waiting the amount time interval 410 after the time 405. Accordingly, such media players are instructed to begin playing the piece of media content so that an initial audio signal of the piece of media content reaches the speakers 320 at a time 435 (“Tstart”).

A time 420 (“Trec”) represents a time at which a media player (e.g., one of the media players 110 and 115) detects (e.g., recognizes) the sync packet. An amount of time interval (“Tnode”), indicated by a dashed line 415, represents an approximate amount of delay between the time 405 (e.g., the time at which the media server outputs the sync packet), and the time 420 (e.g., the time at which the media player detects the sync packet). The amount of time interval 415 is variable in response to the media player's latencies (e.g., software latencies) and the network 125's latencies (e.g., latencies associated with the network 125's traffic).

An amount of time interval, indicated by a dashed line 425 (“Tdecode”), represents an amount of time needed by the media player to decode the specified piece of media content. Accordingly, a time 430 (“Trender”) represents the time at which the media player begins decoding (e.g., rendering) the piece of media content so that an initial audio signal of the piece of media content reaches the speakers 320 at the time 435.

As can be seen from FIG. 4, there are various delays (e.g., network delays and device delays) associated with a playback of a piece of media content. In order to compensate for such delays, the media players of FIG. 1 performs the operations discussed below in connection with FIG. 5.

Accordingly, FIG. 5 is a flow chart of operation of a process executed by one or more of the media players of FIG. 1. The following discussion simultaneously references the FIGS. 4 and 5.

Operation begins at a step 505, where a media player awaits until it has determined that it has received a packet (e.g., a sync packet) that is output by the media server 105. In response to the media player determining that it has received a packet, the operation continues to a step 510.

At the step 510, the media player determines the time (e.g., a time according to the media player's internal clock) at which the packet, received at the step 505, is detected (e.g., recognized and/or received) by the media player. In the illustrative embodiment, the time is represented by the time 420 of FIG. 4. After the step 510, the operation continues to a step 515.

At the step 515, the media player subtracts the amount of time interval 415 from the time 420 to determine the time (e.g., the time 405) at which the media server 105 output the packet. In one example, the amount of time interval 415 is previously determined, and is an approximation of a typical delay between the time 405 and the amount of time interval 415. In such a situation, the time 405 determined is also an approximation of the time at which the media server 105 output the packet. After the step 515, the operation continues to a step 520.

At the step 520, the media player determines the time at which a piece of the media content's initial audio signal reaches speakers that are coupled to the media player. The media player makes such determination in response to information included by the packet. As discussed above in connection with FIG. 4, such information includes the amount of time interval 415. Accordingly, by adding the amount of time interval 415 to the time 405 determined at the step 515, the media player determines the time (e.g., the time 435) at which it is instructed to begin playing the piece of media content. After the step 520, the operation continues to a step 525.

At the step 525, the media player determines the time at which to begin decoding the piece of media content. The media player makes such determination by subtracting an amount of time that is associated with the media player's decoding the piece of media content. In one example, such amount of time is previously determined and is an approximation of a typical amount of time needed by the media player to decode the piece of media content In the illustrative embodiment, the media player subtracts the amount of time interval 425 from the time 435. After the step 525, the operation continues to a step 530.

At the step 530, the media player receives the piece of media content that is provided by the media server. In one embodiment, the media player also buffers the piece of media content in its memory (e.g., the memory 325). After the step 530, the operation continues to a step 535. Although in the illustrative embodiment, the media player receives the piece of media content from the media server at the step 530, in other embodiments, the media player receives the piece of media content before receiving the sync packet (at the step 505).

At the step 535, the media player begins decoding the piece of media content at the time 430 that was determined at the step 525. Accordingly, the media player, after decoding for an amount of time represented approximately by the amount of time interval 425, also begins playing the piece of media content at the time 435.

In the embodiments discussed above, a sync packet is associated with a specific piece of media content. Thus, for a specific piece of media content, the media server outputs a sync packet, in response to which one or more of the media players perform the operations discussed above in connection with FIGS. 4 and 5. Accordingly, each of the media players' plays the piece of media content in a substantially synchronized manner with one another (e.g., at substantially the same time).

Also, each of the media players of FIG. 1 is user selectable for a synchronized playback of a piece of media content. For example, in at least one embodiment, the controller 120 is a hand held IHS such as a PDA, and a user is capable of specifying via the controller 120, whether a media player is to be a part of a synchronized playback for a specific piece of media content. In one version of such embodiment, the user is capable of “registering” a media player as a synchronized device within the network 125. Also, in some embodiments, operations performed by the controller 120 are performed by one or more of the media server 105 and/or the media players 110 and 115.

It has been discovered that a human user is capable of audibly detecting a delay between two playbacks of a single piece of media content if the playbacks begin apart by 20 milliseconds or more. In the illustrative embodiment, each of the media players of FIG. 1 is capable of beginning playback of a piece of media content at a time that is within 10 milliseconds (e.g., 10 milliseconds earlier or 10 milliseconds later) of a time specified by a packet. Accordingly, each of the media players of FIG. 1 is capable of beginning playback of a piece of media content at a time that is within 20 milliseconds of one another.

As discussed above, in at least one embodiment, each of the media players of FIG. 1 buffers a piece of media content its is instructed to play. In one version of such embodiment, in response to an information starvation (e.g., an information starvation cause by a network delay and/or device delay) during a playback, each of the media players re-synchronizes. For performing such re-synchronization, the media server outputs another sync packet that specifies an offset location in a file that includes the piece of media content. Also, in such situation, the media player buffers the piece of media content in a circular manner until an expected portion of the piece of media content is received. In response to performing the re-synchronization, the media player resumes its operation.

Although illustrative embodiments have been shown and described, a wide range of modification, change and substitution is contemplated in the foregoing disclosure. Also, in some instances, some features of the embodiments may be employed without a corresponding use of other features. Accordingly, it is appropriate that the appended claims be constructed broadly and in manner consistent with the scope of the embodiments disclosed herein.

What is claimed is:

1. A method comprising:
outputting a packet, in response to which, two or more media players begin playbacks of a piece of media content at a substantially same time.

2. The method of claim 1, wherein the packet includes an amount of time to wait after the packet is output before beginning the playbacks, and each of the media players determines a time at which to begin its respective playback by adding the amount of time to wait to a time that the packet is output.

3. The method of claim 2, wherein, for each of the media players, the time that the packet is output is determined in response to the time that the media player received the packet.

4. The method of claim 3, wherein, for each of the media players, the time that the packet is output is determined by subtracting a predetermined amount of time associated with a network delay from the time that the media player received the packet

5. The method of claim 1, wherein, each of the media players, before beginning its respective playback, decodes the piece of media content.

6. The method of claim 5, wherein, each of the media players determines a time to begin decoding the piece of media content by subtracting an amount of time associated with the decoding from the time at which to begin its playback of the piece of media content.

7. A method comprising:
receiving a packet; and
in response to the packet, determining a time at which to begin a playback of a piece of media content.

8. The method of claim 7, wherein the packet includes an amount of time to wait after the packet is output, before beginning the playback.

9. The method of claim 8, wherein the determining includes:
adding the amount of time to wait to a time that the packet is output.

10. The method of claim 9, wherein the time that the packet is output is determined in response to a time that the packet is received.

11. The method of claim 10, wherein the time that the packet is output is determined by subtracting a predetermined amount of time associated with a network delay from the time that the packet is received.

12. The method of claim 7, and including:
decoding the piece of media content before beginning the playback of the piece of media content.

13. The method of claim 12, and including:
determining a time to begin a decoding the piece of media content by subtracting an amount of time associated with the decoding from the time at which to begin the playback of the piece of media content.

14. The method of claim 7, wherein the piece of media content is stored in a MPEG Layer 3 (“MP3”) file.

15. The method of claim 7, wherein the receiving the packet includes receiving the packet via Transport Control Protocol/Internet Protocol (“TCP/IP”) network.

16. A system comprising:
an information handling system (“IHS”) for: outputting a packet, in response to which, two or more media players begin playbacks of a piece of media content at a substantially same time.

17. The system of claim 16, wherein the packet includes an amount of time to wait after the packet is output before beginning the playbacks, and each of the media players determines a time at which to begin its respective playback by adding the amount of time to wait to a time that the packet is output.

18. The system of claim 17, wherein, for each of the media players, the time that the packet is output is determined in response to the time that the media player received the packet.

19. The system of claim 18, wherein, for each of the media players, the time that the packet is output is determined by subtracting a predetermined amount of time associated with a network delay from the time that the media player received the packet

20. The system of claim 16, and wherein, each of the media players, before beginning its respective playback, decodes the piece of media content.

21. The system of claim 20, wherein, each of the media players determines a time to begin a decoding the piece of media content by subtracting an amount of time associated with the decoding from the time at which to begin its playback of the piece of media content.

22. A system comprising:
an information handling system (“IHS”) for: receiving a packet; and in response to the packet, determining a time at which to begin a playback of a piece of media content.

23. The system of claim 22, wherein the packet includes an amount of time to wait after the packet is output, before beginning the playback.

24. The system of claim 23, wherein the determining includes:
adding the amount of time to wait to a time that the packet is output.

25. The system of claim 24, wherein the IHS is for: determining the time that the packet is output, in response to a time that the packet is received.

26. The system of claim 25, wherein the IHS is for: determining the time that the packet is output by subtracting a predetermined amount of time associated with a network delay from the time that the packet is received.

27. The system of claim 22, wherein the IHS is for: decoding the piece of media content before beginning the playback of the piece of media content.

28. The system of claim 27, wherein the IHS is for: determining a time to begin decoding the piece of media content by subtracting an amount of time associated with the decoding from the time at which to begin the playback of the piece of media content.

29. The system of claim 22, wherein the piece of media content is stored in a MPEG Layer 3 (“MP3”) file.

30. The system of claim 22, wherein the receiving the packet includes receiving the packet via Transport Control Protocol/Internet Protocol (“TCP/IP”) network.
